(19) United States
(12) Patent Application Publication
(10) Pub. No.: US 2023/0229726 A1
(43) Pub. Date: Jul. 20, 2023

(54) MODAL SUPERPOSITION METHOD USING RESPONSE DEPENDENT NON-LINEAR MODES FOR THE PERIODIC VIBRATION ANALYSIS OF LARGE NON-LINEAR STRUCTURES

(71) Applicant: ORTA DOGU TEKNIK UNIVERSITESI, Ankara (TR)

(72) Inventors: Erhan FERHATOGLU, Torino (IT); Ender CIGEROGLU, Ankara (TR); Hasan Nevzat OZGUVEN, Ankara (TR)

(73) Assignee: ORTA DOGU TEKNIK UNIVERSITESI, Ankara (TR)

(21) Appl. No.: 17/767,949

(22) PCT Filed: Oct. 8, 2020
(86) PCT No.: PCT/TR2020/050929

§ 371 Date: Apr. 11, 2022

(30) Foreign Application Priority Data
Oct. 10, 2019 (TR) 2019/15626
May 27, 2020 (TR) 2020/08177

(51) Int. Cl. G06F 17/11; G06F 17/16; G06F 17/14; G06F 30/23

(52) U.S. Cl. CPC G06F 17/11; G06F 17/16; G06F 17/141; G06F 30/23; G06F 2119/14

(57) ABSTRACT

A modal superposition method using a response dependent non-linear mode concept for a vibration analysis of non-linear engineering structures is provided. The modal superposition method is provided to find steady state response of non-linear systems in frequency domain. The modal superposition method is used in many mechanical structures, especially in design of aerospace and automotive structures, defense industry platforms, steam and gas turbines and mechanical structures containing non-linear forces such as gas turbine engines and jet engines.

### CROSS REFERENCE TO THE RELATED APPLICATIONS

This application is the national stage entry of International Application No. PCT/TR2020/050929, filed on Oct. 8, 2020, which is based upon and claims priority to Turkish Patent Application No. 2019/15626 filed on Oct. 10, 2019, and Turkish Patent Application No. 2020/08177 filed on May 27, 2020, the entire contents of which are incorporated herein by reference.

### TECHNICAL FIELD

The invention is related to a novel modal superposition method using the system response dependent non-linear mode concept for vibration analysis of non-linear engineering structures.

### BACKGROUND

Current methods used in the state of the art are most of the time inadequate and slow, particularly for large structures. There are two different methods available in the literature and used in the industry for the numerical analysis of non-linear systems. Both of these methods are modal based approaches. While the receptance based method (Receptance Method) is preferred when the number of non-linear elements in the system is low, as the number of non-linear elements increase, the modal superposition method is used due to less non-linear equations being solved. In this method, in order to find the non-linear system response, the modes of the linear system are taken as basis. However, most of the time, the number of modes of the linear system used is high in order to increase the accuracy of the system response. This situation brings a high computational burden for particularly large engineering structures, since the number of equations solved increases while the system response is obtained. Despite this, the fastest numerical analysis method before our invention was this method. At design stage, design processes of the engineering parts operating under dynamic loads require taking into consideration of several different alternatives that can be time consuming and for various problems that may arise in these alternatives, solutions for fast analysis are required. The technique proposed in this invention enables fast calculation of vibration amplitudes that have been estimated at an accurate level, which is one of the most crucial necessities of several engineering calculations, primarily for fatigue analysis.

### SUMMARY

The present invention is related to a novel modal superposition method using non-linear modes that are dependent on the system response for periodic vibration analysis of large non-linear structures in order to eliminate the above mentioned disadvantages and to bring about new advantages to the related art.

The novel method has been developed to find a steady state response on the frequency domain of non-linear systems.

The role of the vibration analysis in the design of mechanical structures that operate under dynamic loads is crucial. The requirement of more accurate analyses, which are cost effective and consume minimum energy but with more reliable designs, has risen in the design of mechanical structures such as aerospace and automotive structures, defense industry platforms, steam gas and turbine engine structures. The proposed method can be used in many mechanical structures, especially in the design of aerospace and automotive structures, defense industry platforms, steam and gas turbines and mechanical structures containing non-linear forces such as gas turbine engines and jet engines.

Our invention enables to obtain accurate solution with respect to the number of harmonics used by minimizing the number of non-linear equations that need to be solved for non-linear periodic vibration behaviors of real structures (finite elements and those similarly modeled) that comprise non-linear elements. Together with this, the invention reduces the solution time, as the minimum number of non-linear equations needs to be solved, and at the same time it reduces the stability problems experienced during the solution. The technical problem solved by our invention is to meet the dynamic analysis requirements of complex structures at an accurate level rapidly and in the correct manner. The novel aspects of our invention are the development of Response Dependent Non-linear Modes (RDNM) for vibration analysis of non-linear structures and minimizing the number of non-linear algebraic equations that are required for periodic solutions of non-linear systems with modal superposition method developed by using these modes. The technical solution that is suggested, enables to rapidly and correctly determine the forced vibration amplitudes when the structure is being used, which are required for dynamic analysis of large and complex structures at an accurate level during the design stage. RDNMs are new modes that are obtained by changing the linear system at every solution point, with the help of the Describing Function Method and they are calculated by using the modes of the linear system. As these modes (RDNMs) change with the system response, they are called response dependent non-linear modes (RDNM). The eigenvalue equations have been solved at different modal domains in order to calculate these modes for complex and large systems, thereby reducing the calculation burden. By means of the results obtained using this novel method, the superiority of this method in terms of accuracy and calculation time, has been determined over several different examples, using a realistic and large model. Since the number of RDNMs used was at the lowest level, it has been noted that the proposed method was significantly superior to both the receptance-based method and the mode superposition method used in the literature. These results show that the method developed is a very important analysis method to shorten the very long calculation times required in the design of complex structures in the industry. As a result, several design iterations can be carried out in a more efficient and rapid manner. Therefore, the costs that are required for safer design can be reduced.

### DETAILED DESCRIPTION OF THE EMBODIMENTS

The novelty subject to the invention has been described with examples that do not have any limiting effect but have been provided to further describe the subject matter of the invention.

The invention is related to a novel modal superposition method using the response dependent non-linear mode concept for vibration analysis of non-linear engineering structures. In this invention, a novel modal superposition method using the response dependent non-linear mode concept for vibration analysis of non-linear engineering structures has been developed. With this method, the steady state system responses (displacement, velocity, acceleration amplitudes, etc.) of non-linear structures under periodic excitation can be determined. The technique disclosed in the invention can be used in the dynamic analysis of any non-linear engineering applications that undergo design cycles and are for example structures that are subject to friction, contact and/or bolted structures, materials exhibiting non-elastic behaviors or structures with large deformation. In order to achieve this, first of all, the definition of the matrices that indicate the system properties of the structure to which the technique will be applied and the periodic excitation forces to which the system is subjected should be determined in advance by the designer as an input for the analysis. Any kind of method and/or finite elements software can be used for system matrices. Following this, the equation of motion for the structures subject to periodical force can be written out as follows;

M·\ddot{x}(t)+C·\dot{x}(t)+iH·x(t)+K·x(t)+f_{N}(x(t), \dot{x}(t), . . . )=f(t) (15)

In this equation M, C, H and K respectively represent the mass, viscous damping, structural damping and stiffness matrices of the system. These matrices belong to the engineering structure that was designed and it can be obtained using any kind of commercial finite elements software. f_{N}(x(t), \dot{x}(t), . . . ) and f(t) define internal non-linear forces and periodic external excitation force vectors. Internal non-linear forces are obtained by defining mathematically the non-linear elements used in the system. The periodic external excitation forces represent the environmental forces that the designed engineering structure is subjected to under operating conditions and are often known in advance. x(t) represents the displacement vector of the system, dot represents the derivative with respect to time, i represents the unit imaginary number. The displacement vector represents the vibration responses that are desired to be finally calculated with the suggested technique and they are the unknown values in the equation of motion that is desired to be solved.

At the steady state, the system response of the structures and the internal non-linear force vectors can be written as follows;

$$x ( t ) = {x}_{0} + Im ( {\sum }_{h = 1}^{{n}_{h}} {x}_{h} {e}^{ih ω t} ) \qquad ( 16 )$$

$${f}_{N} ( x ( t ) , ω ) = {f}_{N , 0} + Im ( {\sum }_{h = 1}^{{n}_{h}} {f}_{N , h} {e}^{ih ω t} ) \qquad ( 17 )$$

Expressions x₀ and f_{N,0}, mentioned in Equations (2) and (3) represent the real valued bias amplitude vectors of the system response and the internal non-linear forces, respectively. The expressions Xₕ and f_{N,h} represent the complex amplitude vectors of the system response and the internal non-linear forces for the h^{th} harmonic, respectively. nₕ represents the total number of harmonics taken into consideration in the expansion. e is the Euler's number. The Im expression shows that imaginary part of the expressions, which are defined as complex numbers, should be taken. Using the response dependent non-linear modes developed with this invention and the modal superposition method, the response vector can be written as follows.

xₕ=Φ_{N}·qₕ(h=0,1, . . . , nₕ) (18)

qₕ represents the response coordinates in the modal domain for the h^{th} harmonic. The response dependent non-linear modes, Φ_{N}, can be calculated for each frequency point during solution.

Φ_{N}=Φ\tilde{Φ} (19)

Φ shows the modal matrices of the original linear system and \tilde{Φ} shows modal matrix of modified the linear system and they are obtained as the results of the eigenvalue problem below mentioned.

K·u=ω²M·u (20)

[Ω+Φ^{T}Δₗ^{re}Φ]·ũ=\tilde{ω}²I·ũ (21)

u and ω in Equation (6) show the mode vector and natural frequencies of the original linear system, respectively, and Ω in Equation (7) shows the diagonal matrix formed of the square of the natural frequencies of the original linear system obtained from the solution of Equation (6) and ũ and \tilde{ω} represent respectively the mode vector and the natural frequencies of the modified linear system. I represents the diagonal unit matrix. The expression Δₗ^{re} in Equation (7), is obtained from the Describing Function Method. This method shows that the non-linear internal forces matrix, can be written as a multiplication of a non-linear complex matrix and the response vector as follows.

f_{N,h}=Δₕ·xₕ (22)

While the system matrices of the linear system are required for solving the eigenvalue problem in Equation (6), it is sufficient to know the natural frequencies of the linear system Ω, and mode shapes, Φ, for the eigenvalue problem in Equation (7). This information can be obtained from any finite element software only once. This difference in Equations (6) and (7) highlights the method proposed by this invention. When Equation (7) is used, the modes that have no effect on the response of the system are removed from the eigenvalue problem, an eigenvalue problem having a smaller size shall be obtained, therefore, a significant amount of time shall be gained without losing the accuracy of the solution. The mode shape vector of the modified system obtained from the solution of this problem is represented by ũ. While only the modified mode shape vectors of small-sized systems can be obtained with Equation (6), Equation (7) provides mode shapes vectors of large modified systems that are modeled with both small and large-sized realistic finite element methods. The obtained vectors form the columns of \tilde{Φ} (the modal matrix of the modified linear system). After this step, the Response Dependent Non-linear Modes (RDNM) matrix can be obtained using Equation (5). Additionally, the analysis time can be shortened by solving only the number of eigenvalues and vectors thereof that are desired to be used in the analyses when solving the eigenvalue problem in Equation (7). In this way, the method can be used in all kinds of small or large systems without any restrictions, as RDNM can be obtained at short calculation times for any system.

As a result, when Equations (2), (3), (4) and (5) are placed in the equation number (1), the equation of motion can be turned into a non-linear algebraic set of equations as follows.

\tilde{Φ}^{T}Ω\tilde{Φ}·q₀+Φ_{N}^{T}f_{N,0}=Φ_{N}^{T}f₀ (23)

[\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ(h=1, 2, . . . , nₕ) (24)

Equations (9) and (10) show the final set of equations that must be solved in order to obtain the response vectors, which require iteration through numerical approximations.

This non-linear equation system can not only be solved by using the Newton's Method and its variations, but it can also be solved by using any kind of numerical method that has been developed for solving non-linear equations. The most important part herein is that the RDNM that is described with Equation (5) Φ_{N} needs to be obtained again and again in every iteration. Due to this reason Φ_{N} has been defined as the Response dependent non-linear mode matrix. Although Φ_{N} needs to be re-calculated in every iteration, it may not need to be calculated for all iterations carried out for a point for which a solution is being sought, depending on the accuracy level of the desired response. Therefore, it may be possible to calculate Φ_{N} at certain intervals. If this feature of the proposed method is to be used, Equation (7) should be solved at regular intervals, not at every solution point. For example, RDNM matrix, in other words Φ_{N} obtained using the system response at the final iteration of each previous point can be used at the next solution point without being changed at all. In this way, the total solution time can be decreased without almost changing the accuracy of the solution.

For example, when Equation (9) is desired to be solved by Newton's method that uses the arc length continuation method, the following steps can be taken. First of all Equations (9) and (10), which are complex numbers, can be written as real valued residual vectors as follows.

R(b, ω)=0, b=(qᵣₑqᵢₘ)^{T} (25)

In Equation (11) qᵣₑ and qᵢₘ represent the real and imaginary parts of the unknown modal coordinates. To write out the residual vector, the terms on the right hand side of Equation (9) and (10) are moved to the left side of the equation and the real and imaginary parts of the equation are written out separately. Due to this reason, the total number of equations increases to the summation of the number of the equations defined in Equation (9) and twice the number of equations defined in Equation (10).

By using this method, the number of equations provided in Equation (11) is minimized for a certain harmonic. For example, in the case that the modes of the linear system are separated, it is sufficient to use 1 mode in Φ_{N} , and in this case the total number of equations is 2nₕ+1. If there is a coupling between some of the modes of the system (for example, if they are not separated), more modes may have to be used. Since the number of modes to be used is minimized with this method that has been developed, the method reduces the number of equations for all kinds of systems. For example, in a case where 2 modes are used in Φ_{N} the total number of non-linear equations become 2(2nₕ+1).

The iteration formula for Newton's Method, which uses the arc length continuation method, can be written as follows.

$${{a}_{k}^{j + 1} = {a}_{k}^{j} - {[ \begin{matrix}\frac{\partial R ( b , ω )}{\partial b} & \frac{\partial R ( b , ω )}{\partial ω} \\ \frac{\partial h ( b , ω )}{\partial b} & \frac{\partial h ( b , ω )}{\partial ω}\end{matrix} ]}^{- 1} \vert}_{{b}_{k}^{j} , {ω}_{k}^{j}} \times \{ \begin{matrix}R ( {b}_{k}^{j} , {ω}_{k}^{j} ) \\ h ( {b}_{k}^{j} , {ω}_{k}^{j} )\end{matrix} \} \qquad ( 26 )$$

$$where$$

$${a}_{k}^{j} = \{ \begin{matrix}{b}_{k}^{j} \\ {ω}_{k}^{j}\end{matrix} \} \qquad ( 27 )$$

$$and$$

$$h ( {b}_{k}^{j} , {ω}_{k}^{j} ) = {( {a}_{k}^{j} - {a}_{k - 1} )}^{T} \cdot ( {a}_{k}^{j} - {a}_{k - 1} ) - {s}^{2} = 0 \qquad ( 28 )$$

S shows the arc length parameters, k shows the current solution point, j shows the iteration number in the equation numbered (14).

The novel modal superposition method using the response dependent non-linear mode concept for vibration analysis of non-linear engineering structures comprises the following process steps;
The equation of motion is obtained as Equation (1) after defining the system matrices of the non-linear engineering structure, the non-linear elements in the system and the external excitation forces of the non-linear engineering structure for which the steady-state vibration response is desired.
After deciding upon the number of harmonics that is foreseen to be used in the solution, system response and internal non-linear forces can be written out as periodic functions by using Fourier series, as shown in Equation (2) and (3).
In order to apply the modal superposition method with the suggested technique, the displacement vector written as a periodic function using Fourier series, the non-linear force vector and the external excitation vector is placed inside the motion vector. Following this the displacement vector is replaced with the RDNM matrix times the modal coefficient vector. As a result of this process, a non-linear complex equation system is obtained in the modal domain for the non-linear system. (Equations (2), (3), (4) and (5); are substituted in Equation (1) to obtain Equations (9) and (10)).
The modal matrix and natural frequency information of the linear system is obtained only once by solving the eigenvalue problem of the related system or by using any kind of finite element software. (The eigenvalue problem mentioned in Equation (6) is determined for once only by solving said problem.)
In order to solve the response dependent non-linear modes (RDNMs) within the equation system (Equation (9) and (10)) mentioned in item 3, and suggested by this method, first of all the real section of the non-linearity matrix that has been obtained using the Describing Function Method (DFM) is taken as a modification that has been carried out on the stiffness matrix of the linear system and then a new eigenvalue problem is established for this system. Each term in this new eigenvalue problem is multiplied from the left by the transpose of the modal matrix of the linear system and from right with itself. As the modal matrix of the linear system is orthogonal with the system matrices of this system, a new eigenvalue problem (Equation (7)) is obtained which comprises the diagonal matrix comprising the square of the natural frequencies of the linear system, the unit matrix and the transpose of the modal matrix of the linear system times the real part of the non-linearity matrix obtained by DFM times the modal matrix itself . This eigenvalue problem is solved at each frequency point or at certain intervals and the modal information (mode vectors and new eigenvalues) of the changed linear system is obtained. After this, by using this information, the RDNMs are calculated by multiplying the modal matrix of the linear system with the modal matrix obtained from the solution of this eigenvalue problem (as shown in Equation (5)). The eigenvalues corresponding to each RDNM are the new eigenvalues calculated in this step.
After this step, the mode coefficient vector remains as the only unknown in the non-linear equation system obtained in item 3. This equation describes a system of equations that is formed by complex numbers. As some numerical solution methods cannot be applied for complex numbers, the real and imaginary parts of the complex equation may have to be written separately and the newly obtained equation system may have to be solved. The obtained non-linear equation system can be solved by using any kind of numerical solution method, whether they are written with complex or real numbers.

The novel modal superposition method using the response dependent non-linear mode concept for vibration analysis of non-linear engineering structures comprising the following process steps;
Obtaining the M·\ddot{x}(t)+C·\dot{x}(t)+iH·x(t)+K·x(t)+f_{N}(x(t), \dot{x}(t), . . . )=f(t) equation, which is the equation of motion after defining the system matrices of the non-linear engineering structure, the non-linear elements in the system and the external excitation forces of the non-linear engineering structure for which the steady vibration response is desired,
After deciding upon the number of harmonics, system response and internal non-linear forces are written out as periodic functions by using Fourier series as

$$x ( t ) = {x}_{0} + Im ( {\sum }_{h = 1}^{{n}_{h}} {x}_{h} {e}^{ih ω t} ) and$$

$${f}_{N} ( x ( t ) , ω ) = {f}_{N , 0} + Im ( {\sum }_{h = 1}^{{n}_{h}} {f}_{N , h} {e}^{ih ω t} ) ,$$

In order to apply the modal superposition method with the suggested technique, the displacement vector, the non-linear force vector and the external excitation vector that are written as periodic functions using Fourier series are substituted into the equation of motion, which is M·\ddot{x}(t)+C·\dot{x}(t)+iH·x(t)+K·x(t)+f_{N}(x(t), \dot{x}(t), . . . )=f(t), and following this replacing the displacement vector with RDNM matrix times the modal coefficient vector, as a result of this the equation \tilde{Φ}^{T}Ω\tilde{Φ}·q₀+Φ_{N}^{T}f_{N,0}=Φ_{N}^{T}f₀ and [\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ (h=1, 2, . . . , nₕ) that is the non-linear complex equation system is obtained in the modal domain for the non-linear system,
Obtaining the modal matrix and natural frequency information of the linear system once only, by solving the eigenvalue problem mentioned in the equation K·u=ω²M·u of the system or by using any kind of finite elements software, and in order to calculate the response dependent non-linear modes (RDNMs) included in the \tilde{Φ}^{T}Ω\tilde{Φ}·q₀+Φ_{N}^{T}f_{N,0}=Φ_{N}^{T}f₀ and [\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ (h=1, 2, . . . , nₕ) equations, handling first of all, the real section of the non-linear matrix obtained using the Describing Function Method (DFM) of the non-linear system as a change that has been made in the stiffness matrix of the linear system and establishing the new eigenvalue problem for this system, multiplying each term in this new eigenvalue problem, from the left with the transpose of the modal matrix of the linear system and with itself from the right, as the modal matrix of the linear system is orthogonal with the system matrices of this system, obtaining (f_{N,h}=Δₕ·xₕ), which is the new eigenvalue problem equation with [Ω+Φ^{T}Δₗ^{re}Φ]·ũ=\tilde{ω}²I·ũ, which comprises the diagonal matrix of the square of the natural frequencies of the linear system, the unit matrix and the transpose of the modal matrix of the linear system times the real section of the non-linear matrix obtained by DFM times the modal matrix itself, obtaining the modal information (mode vectors and new eigenvalues) of this modified linear system by solving this eigenvalue problem at each frequency point or at certain intervals, following this, calculating the RDNMs using the Φ_{N}=Φ\tilde{Φ} equation with the multiplication of the modal matrix of the linear system and the modal matrix obtained from the solution of this eigenvalue, wherein the eigenvalues that correspond to each RDNM being new eigenvalues that are calculated in this step,
After this step, determining the non-linear equation system defined with equations \tilde{Φ}^{T}Ω\tilde{Φ}·q₀+Φ_{N}^{T}f_{N,0}=Φ_{N}^{T}f₀ and [\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ (h=1, 2, . . . , nₕ),
Solving the modal coefficient vector as the single unknown in the non-linear equation system.

What is claimed is:

1. A modal superposition method using a response dependent non-linear mode concept for a vibration analysis of non-linear engineering structures, comprising the following steps of:
after defining system matrices of a non-linear engineering structure, non-linear elements in a system, and external driving forces of the non-linear engineering structure, wherein a steady vibration response is desired for the non-linear engineering structure, obtaining an equation of motion as M·\ddot{x}(t)+C·\dot{x}(t)+iH·x(t)+K·x(t)+f_{N}(x(t), \dot{x}(t), . . . )=f(t),
after deciding upon a number of harmonics, writing out a system response and internal non-linear forces as periodic functions by using Fourier series as
$$x ( t ) = {x}_{0} + Im ( {\sum }_{h = 1}^{{n}_{h}} {x}_{h} {e}^{ih ω t} ) and$$
$${f}_{N} ( x ( t ) , ω ) = {f}_{N , 0} + Im ( {\sum }_{h = 1}^{{n}_{h}} {f}_{N , h} {e}^{ih ω t} ) ,$$
in order to apply the modal superposition method, substituting a displacement vector, a non-linear force vector, and an external excitation vector inside the equation of motion, wherein the displacement vector, the non-linear force vector, and the external excitation vector are written as a periodic function using the Fourier series, and replacing the displacement vector with a response dependent non-linear mode (RDNM) matrix times a modal coefficient vector to obtain equations \tilde{Φ}^{T}Ω\tilde{Φ}·q₀+Φ_{N}^{T}f_{N,0}=Φ_{N}^{T}f₀ and [\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ (h=1, 2, . . . , nₕ) forming a non-linear complex equation system in a modal domain for a non-linear system,
obtaining for once only modal matrix and natural frequency information of a linear system, by solving an eigenvalue problem mentioned in an equation K·u=ω²M·u of the system or by using any kind of finite elements software, and to calculate RDNMs included in the equations \tilde{Φ}^{T}Ω\tilde{Φ}·q₀+Φ_{N}^{T}f_{N,0}=Φ_{N}^{T}f₀ and [\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ (h=1, 2, . . . , nₕ), handling, first of all, a real section of a non-linear matrix obtained using a Describing Function Method (DFM) of the non-linear system as a modification made in a stiffness matrix of the linear system and establishing a new eigenvalue problem for the linear system, multiplying each term in the new eigenvalue problem, from a left with a transpose of the modal matrix of the linear system and with the modal matrix from a right, as the modal matrix of the linear system is orthogonal with the system matrices of the linear system, obtaining a new eigenvalue problem equation [Ω+Φ^{T}Δₗ^{re}Φ]·ũ=\tilde{ω}²I·ũ comprising a diagonal matrix of a square of natural frequencies of the linear system, an identity matrix and the transpose of the modal matrix of the linear system times the real section of the non-linear matrix obtained by the DFM times the modal matrix, obtaining modal information of a modified linear system by solving the new eigenvalue problem at each frequency point or at certain intervals, wherein the modal information is modal vectors and new eigenvalues, and calculating the RDNMs using Φ_{N}=Φ\tilde{Φ} equation with a multiplication of the modal matrix of the linear system and the modal matrix obtained from a solution of the new eigenvalue problem, wherein eigenvalues corresponding to each RDNM are the new eigenvalues calculated in this step,
obtaining a non-linear equation system defined with equations \tilde{Φ}^{T}Ω\tilde{Φ}·q₀+Φ_{N}^{T}f_{N,0}=Φ_{N}^{T}f₀ and [\tilde{Φ}^{T}(Ω−(hω)²I+iH_{d}+ihωC_{d})\tilde{Φ}]·qₕ+Φ_{N}^{T}f_{N,h}=Φ_{N}^{T}fₕ (h=1, 2, . . . , nₕ), and
solving the modal coefficient vector as a single unknown in the non-linear equation system.
